(19) United States
(12) Patent Application Publication
(10) Pub. No.: US 2010/0322708 A1
(43) Pub. Date: Dec. 23, 2010

(54) LIGHT GUIDE SYSTEM

(75) Inventors: Franciscus Johannes Lebens, Eindhoven (NL); Franciscus Guillaume Peter Sools, Mierlo (NL)

Correspondence Address: NIXON & VANDERHYE, PC, 901 NORTH GLEBE ROAD, 11TH FLOOR, ARLINGTON, VA, 22203, US

(73) Assignee: ACTMA HOLCING B.V., Eindhoven (NL)

(21) Appl. No.: 12/681,828

(22) PCT Filed: Sep. 29, 2008
(86) PCT No.: PCT/EP08/63013

§ 371 Date: Aug. 6, 2010

(30) Foreign Application Priority Data
Oct. 9, 2007 (EP) 07118074.9

(51) Int. Cl. E01F 9/087; G02B 27/00; G02B 27/10

(52) U.S. Cl. 404/12; 359/896; 359/618

(57) ABSTRACT

A light guide system for receiving and transporting ambient light by means of light guides, which system comprises at least one light collecting unit for receiving light and light transporting means to transport the received light to a location remote from the unit, is described wherein the said light collecting unit comprises a number of light guides, the light receiving ends of which are arranged in a two dimensional array of rows and columns whilst downstream these ends the light guides stepwise compose to a number of outgoing transport light guides, which number is substantially lower than the number of light receiving ends and which transport light guides constitute said light transport means. The system has a large light-collecting capability and can be made very compact and is especially very suitable for a road marking system.

### BACKGROUND OF THE INVENTION

The present invention relates to a light guide system for receiving and transporting ambient light by means of light guides, which system comprises at least one light collecting unit for receiving light and light transporting means for transporting received light to a location remote from said unit.

Such a system may be used in, for example a passive road marking system for marking road portions ahead a vehicle driver and/or for warning traffic behind said vehicle.

Ambient light is understood to mean light that is, in first instance, present in a space for reasons and/or purposes other than irradiating the light guide system. Such ambient light is for example light from a vehicle headlamp, which light is intended to illuminate a road portion in front of the vehicle driver. It my also be light from other radiation sources, which are used for other purposes. The light guide system allows a second use of this light at a location remote from the location where it is generated. Ambient light may also be sunlight.

A passive road marking system is understood to mean a system that does not comprise own light sources, but uses light that is already present. Such a system may be used, for example for roadways or sections thereof for which full artificial lighting during hours of darkness does not merit, because these roadways do not carry sufficient traffic density. Artificial lighting of roadways requires a lot of energy so that this will be avoided wherever and whenever possible. Also in free or protected natural regions artificial road lighting is not wanted or even not allowed, because this contribute to so called light pollution, which is becoming an increasing global problem, especially in the neighborhood of crowded regions.

There is thus a need for a road marking, or visibility, system that does not consume energy and is switched on, or emitting light, locally only when this is needed. Conventionally, such a system comprises a series of so-called cat's eyes on the road, which comprise reflecting elements resiliently mounted in castings partly sunk into the road surface and sealed in place with, for example bitumen or concrete. The reflecting elements reflect incident light from a car's headlight. The car driver will thus see only reflections from the cat's eyes that are within the pool of light from his headlights so that the road visibility distance is limited. When a driver dips his headlight beam, for example, because another car is coming from the opposite direction, the light beam from his headlights will be relatively small and the road visibility distance will be further reduced. Moreover, once the road has turned by a certain amount, the cat's eyes will be at the wrong orientation to reflect light back to a driver so that only the initial part of any road turn can be seen and this may occur at a moment too late to slow down. Moreover, to be effective, the cat's eyes should raise minimally, for example 5 mm above the road surface, whilst for safety reasons only 3 mm is allowed.

PCT patent application WO 88/07560 discloses that the problem of short distance visibility of a passive road marking system can be solved by using a series of light receivers and a series of light transmitters, both series being fixed relative to a vehicle trackway, whereby each receiver is arranged to react to light from a vehicle headlight such as to cause at least one transmitter remote from the receiver to transmit light. In a preferred embodiment each light receiver is connected by an optical fiber to a single light transmitter. As a vehicle moves along the road with its headlights switched on, radiation from these headlights is incident successively on the light receivers and transferred along the optical fibers to the associated light transmitters, which transmitters successively emit light. In this way the visibility distance can be increased, dependent on the distance between an associated receiver-transmitter pair. Also transmitters arranged in the turn of a road may receive light from their associated receiver so that the turn is made visible to the driver in time.

However, it is our firm believe that the system according to patent application WO 88/07560 will not perform adequately in practice because it does not satisfy the lighting requirements for a roadway system. This is confirmed by the fact that, according to our best knowledge, this system has not been realized.

U.K. patent application GB 2314107 discloses a road visibility system having a series of light receiving/emitting units wherein also optic fibers are used to transport light from each of the units to other units. Each unit comprises a convex receiving lens to receive light from vehicle headlights and a concave emitting lens to emit light received from other units to a vehicle driver. Specific for this system is that at both sides of a light receiving lens a fiber is arranged to transport light received by the lens to the light emitting lens of the preceding unit and of the succeeding unit, whilst at both sides of an emitting lens a semi-reflecting surface and three fibers are arranged so that only part of the received light is emitted and the rest is sent to the emitting lenses of preceding and succeeding units. This system is also not suitable to be implemented in a roadway.

### SUMMARY TO THE INVENTION

It is an object of the present invention to provide a passive visible-light transport system that has both improved light receiving capacity and a compact construction and is very suitable not only for a road marking system, but also for other applications. This system is characterized in the at least one light collecting unit comprises a number of light guides, the light receiving ends of which are arranged in a two dimensional array of rows and columns whilst downstream these ends the light guides stepwise compose to a number of outgoing transport light guides that is substantially lower than the number of light receiving ends, and which transport light guides constitute said light transport means.

The terms stepwise compose is understood to mean that the primary light guides, which are provided with the light receiving ends, flow together in secondary light guides and the secondary light guides again flow together and so on, such that finally all light received by the receiving ends of the light guides within a unit is concentrated into a few number of outgoing light guides. Thus the light guide structure in a unit is an inverted tree structure.

The invention is based on the insight that a passive light transport system can be effective only if an amount of ambient light is captured that is substantially larger than the amount of light that can be captured by a linear array of single and spaced light receivers, even if these receivers are provided with a lens. Effective is understood to mean that the system is able to supply at required positions the required amount of light such that at these positions the required function, for example emitting sufficient guidance light towards a vehicle driver, can be performed. This is realized by using a large number of light guides at the said first position, i.e. a road surface area or other road site, that is flooded by the light of a vehicle head light. First ends of these fibers constitute the light receivers and, compared with prior art systems, the light receiving area is substantially increased.

A second insight underlying the invention is that such a large number of light guides starting at the flooded area cannot be extended as a packet of the same number of light guides to the second areas where the light is to be utilized, because such a packet would be to bulky, vulnerable and expensive. For example, a light guide system that is to be laid in or on a road way should have a very limited height, because the road way should be kept intact as much as possible in order to maintain its mechanical strength. A very important and inventive aspect of the new light guide system is that all light guides of a unit are united in a small number of light guides so that for transport of light from a first unit to a second unit, thus for the longer distances in the system, only a few light guides are needed, so that the system can easily be implemented in existing constructions, for example road ways, tunnels etc.

It is remarked that the English abstract and drawings of Mexican patent application MX PA03011492 disclose a self-illuminated road security and signaling system, which comprises a linear array of modules arranged along a road way. Each module comprises a number of optical fibers, which light receiving end faces are arranged in a two dimensional array in a module surface that is exposed to the headlight of a vehicle. The fibers transport the received light to next modules via connector elements and a fiber cable arranged between the module. The number of fibers in the fiber cable is equal to the number of fibers in a module and thus is not substantially reduced, so that this system does not show the main feature of the present invention.

Since the inventive concept of the invention is a very general concept, it may be used not only in road marking systems such as for road vehicles, trains and airplanes, but also in other systems including systems wherein up to now such light guide transport system have not been used. Examples of such systems are displays for traffic ways or otherwise, and indoor or outdoor lighting systems.

It will be appreciated that the system of the invention is a completely passive system, which requires no external light power input other than already present ambient light, such as light from vehicles, streetlights or sunlight. The system therefor requires minimal maintenance, and the compact light guide structure can be easily embedded in, for example a road surface or a building during construction of the road or building, or afterwards.

A simple embodiment of the system is provided with a second unit that comprises a casing with only one or a few light guide(s), which provides light, which may be used for different purposes, for example a mark or a simple display.

A light guide system according to the invention, which is especially, but not exclusive, suitable for road marking, is preferably characterized in that it comprises a number of at least one further collecting units, which include light receiving light guides arranged in a similar way as the light guides in the first light collecting unit.

In this embodiment the ambient light available at the area of a further unit can be captured and transported to a remote unit so that the efficiency of the system is doubled. Also other further units of the system may show this feature, so that the amount of light coupled into the system increases with the number of units. Thereby the light received by one unit may be transported to one other remote unit to be used at this unit. It is also possible to transport the combined light received by a number of units to one remote location. It will be clear that the envisaged application determines which option will be chosen.

An embodiment of the system that is specific, but not exclusive, suitable for road marking is preferably characterized in that the further collecting units comprise light splitting and combining means for splitting light received from a preceding unit into a light portion that is emitted by this unit and a light portion that is transferred to HI the succeeding unit and for combining the light received by this unit with the transferred light.

Thus, proceeding along the series of units, the amount of received light increases per unit, so that loss of light is compensated. In this way the most efficient embodiment is obtained. The light emitted by a unit may be only a small portion of the light transported to this unit from the preceding unit(s). In principle there is no need for said light splitting and combining means in the first unit, but for efficient manufacture uniform units are preferred so that in practice also the first unit will be provided with said beam splitting and -combining means.

The system is preferably characterized in that the light guides of a collecting unit stepwise compose to a number of at least one outgoing light guides.

If the units show only one or a few outgoing light guides, the system can be made very compact and very well protected and is easily implementable in existing constructions.

The system is preferably characterized in that each row of light receiving light guide ends comprises a number of spaced-apart transparent windows for passing light to a number of receiving light guide ends.

An embodiment of the light guide system is characterized in that for each window primary light guides provided with the light receiving ends associated with this window compose to a secondary light guide.

This embodiment is preferably further characterized in that for each row of windows the secondary light guides compose to a tertiary light guide.

In this way a practical receipt for obtaining a minimum number of outgoing light guides is obtained. For a further reduction of the number, the tertiary light guides of the row may compose to a fourthly light guide.

In order to increase the amount of received light the system may be characterized in that the receiving light guide ends are provided with a lens.

Thus the portion of the light passing a window that can be captured by the associated light guides can be increased.

It is also possible to provide the windows with a lens so that the amount of ambient light that can be captured by the window is increased. It is also possible that both the window and the associated receiving light guides are provided with a lens.

The light guide system may be further characterized in that in the light path behind each window at least a first of a first and second reflecting surface is arranged to reflect light to the associated receiving ends of light guides.

The light guides may be optical fibers or optical waveguide. Optical fibers, showing a circular cross section and wherein light propagates along a core that is enveloped by a cladding, which are suitable for this purpose are readily available. A waveguide structure, wherein light propagates in channels having a more or less rectangular cross-section, for this purpose is more sophisticated and requires design efforts. Manufacturing a light-collecting unit including a waveguide structure requires less process steps than manufacturing of a unit including optical fibers. The specific application of the light guide system will determine whether optical fibers or a waveguide structure is preferred.

The invention also relates to a road marking system, which comprises a light guide system as described herein above. This road marking system is characterized in that the collecting units of the light guide system are elongated in the drive direction and arranged in a series in this direction.

In this way light from vehicles will be collected all along the distance covered by the vehicle and the received light will be available at required remote locations. The mutual distance of the collecting unit is determined by specific road requirements. If a continuous lighting strip is required, the units should be arranged against each other. If it suffices having spaces lighting marks, the collecting units can be arranged at a mutual distance of for example one to ten times the length of a unit, to be determined by the road authority.

This road marking system is further characterized in that each collecting unit comprises at least one light emitting light guide to direct light to a vehicle driver.

It has been demonstrated that with only one light emitter per unit a vehicle diver will receive sufficient visual signal. Thus, the largest part of the light from preceding units and the present unit can by sent to the units ahead. The light guide system allows the emitter to emit a light intensity of, for example 500 milli Candela, which is required for a dark road. The light emitter(s) may be accommodated into (a) window(s) of the collecting unit and the associated light guide may be one of the light guides associated with the window.

Preferably, the road marking system is characterized in that the rows of windows are arranged at an angle with the drive direction, which angle is adapted to the position of the collecting unit in the width direction of the road. For a system that is to be arranged at the right side of a straight drive lane, the rows are inclined towards the lane axis at an angle of, for example 75°, to the lane axis and for a system that is to be arranged at the axis of the straight lane the rows are inclined towards to the lane axis at a larger angle. For a bent lane portion another angle may be chosen. This adaptation of the row orientation to the intensity distribution of vehicle headlight way allows receipt of an in creased amount of light.

A further main aspect of the present invention relates to the specific problems, which arise when implementing the concept of the new light guide system in a robust and tight road marking system that is suitable for use in severe circumstances. These problems relate to the mechanical strength the plate-shaped unit should have although it is provided with transparent windows and to the requirement that sufficient light should always reach the windows, despite the fact that a roadway is a very unfriendly environment for a light-collecting device.

To solve the mechanical-strength problem, the road marking system is characterized in that at the upper surface of a collecting unit the windows of each row are each arranged between two columns, which are perpendicular to the surface and covered by a bar parallel to the surface and in that the plate surface areas in front of the windows are declined to the lower sides of the windows and bordered by raising members.

The said plate surface areas, which may be called light entrance enabling areas, warrant that sufficient light reaches the windows. The columns and bar constitute a mechanical protection for the windows. And the raising members together with the columns absorb the pressure exerted by a vehicle wheel rolling across the unit plate.

Preferably, the road marking system is characterized in that in a plane parallel to the unit surface the raising members have the shape of a triangle, the top of which faces the preceding row of windows.

This shape of the raising members allows optimizing the size of the light entrance enabling areas at the one hand and mechanical strength at the other hand.

A further improvement of the mechanical protection of the windows is obtained in a road marking system that is characterized in that the windows of a row and the intermediate columns are covered by one bar and in that this bar has a crenellated upper surface.

The bar portions on top of the columns rise above the bar portions on top of the window, so that the former portions and thus the columns, together with the raised members will initially absorb the pressure of a vehicle wheel, so that less pressure is exerted on the windows.

To prevent water and dirt from covering the unit surface structure and thus frustrating functioning if the road marking system, this system is further characterized in that the raising members associated with a row of windows extend from a preceding row to near the associated columns of the first mentioned row.

Since the raising members do not flow into associated columns and some space is left between them, gutters are created at the lowest portion of the unit surface for removing water and dirt from the surface. Dirt can also be removed by air turbulence caused by vehicle wheels rolling across the collecting unit.

Improved water and dirt removal is obtained in a road marking system that is characterized in that upper surface of a unit is at both sides of the rows of windows provided with a groove that has one steep wall and one inclined wall.

This groove causes extra turbulence when a vehicle wheel is rolling across the collecting unit, which results in an improved water and dirt removal.

### BRIEF DESCRIPTION OF THE DRAWING

These and other aspects of the invention will be apparent from and elucidated by way of non-limitative example with reference to the embodiments described hereinafter.

In the drawings:

FIG. 1 shows a prior art vehicle-guidance system;

FIG. 2 shows, in perspective, a unit as used in the system of FIG. 1;

FIG. 3 shows a principle diagram of a unit according to the invention;

FIG. 4 shows a top view of an embodiment of such a unit;

FIG. 5 shows a front view of a row of windows of such a unit;

FIG. 6 shows a cross-section of an interior light path to a light guide;

FIG. 7 shows schematically how primary light guides are composed to secondary light guides;

FIG. 8 shows an artificial component representing the light splitting and light combining functions included in a collector unit;

FIG. 9 shows in perspective a portion of a unit for use in a road marking system;

FIG. 10 shows a front view of a crenellated upper surface of this unit;

FIG. 11 shows a cross-section of the portion of the unit;

FIG. 12 shows a first another application of the new light guide system, and

FIG. 13 shows a second another application of the new light guide system.

### DETAILED DESCRIPTION OF PREFERRED EMBODIMENTS

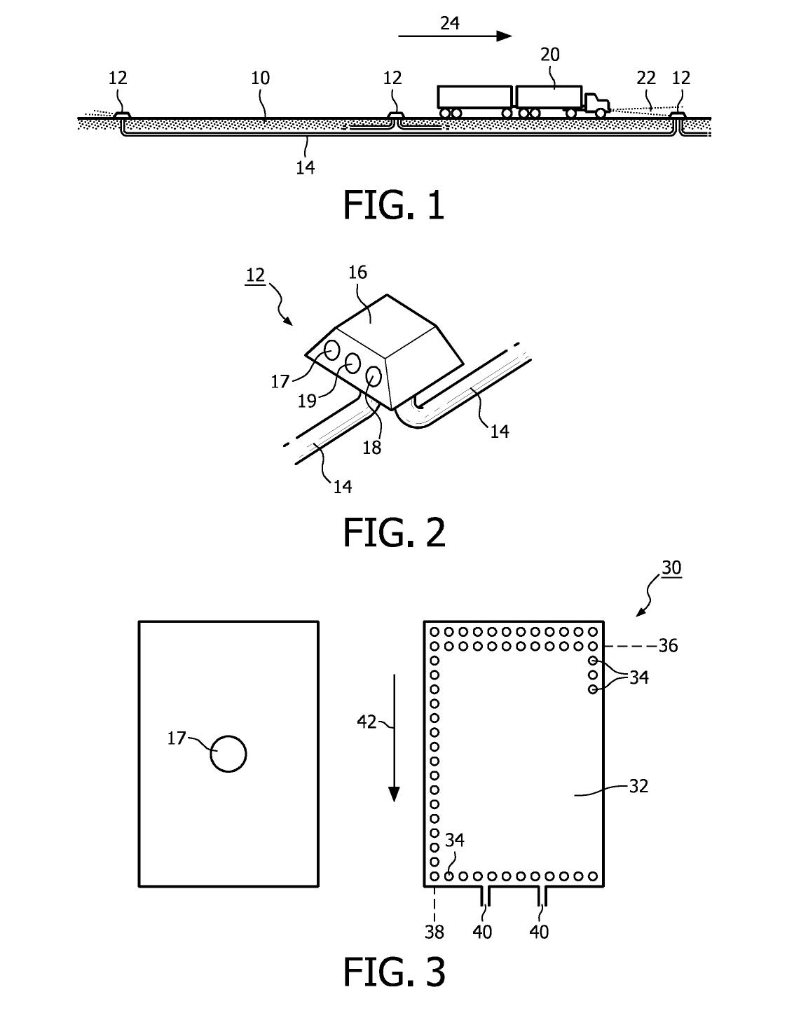

For a better understanding of the present invention a vehicle guidance and proximity warning system that is known from PCT patent application WO 88/07560 will be briefly discussed. FIG. 1 shows an elevation of a road 10, which is provided with a vehicle warning system. This system comprises a plurality of marking and/or warning units 12 and fiber optic cables 14 for optically connecting a unit with another one. The units 12 are embedded in the surface of the road 10 and the fiber cables are buried in the road. As shown in FIG. 2, each unit 12 comprises a housing in the form of a block 16 of rubber or similar material, which is adapted to retract in the road surface when contacted by a wheel of a vehicle. Partially enclosed in the block 16 are a receiving lens 17, a transmitting lens 18, and a reflector 19, whereby the receiving lens of a unit is optically connected with the transmitter lens of another unit.

As a vehicle 20 moves along the road 10 with its headlight switched on, the light 22 from the headlights falls on the receiving lenses 17 of successive units 12 and is transferred along fiber optic cables 14 to associated transmitting lenses 18 of, for example rearward units. The successive transmitting lenses transmit light, which may red colored by means of a color filter, to a driver of a following vehicle so that the latter is advanced warned that vehicle 20 is ahead of him. By optically connecting receiving lenses with transmitting lenses ahead, in the direction 24 of vehicle motion, a vehicle guidance system is obtained whereby the transmitting lenses act as road markers.

In this vehicle guidance system road marks (transmitting lenses) at positions along the drive direction ahead of the road area momentarily illuminated by the vehicle headlights are made visible to the driver. In this way the maximum distance at which a driver can see a road mark is enlarged. Moreover it becomes possible for the driver to see a road mark in a bent of the road. The mark viewing distance is determined by the length of the fiber cable between a receiving lens 17 and the associated transmitting lens and by the amount of light captured by the receiving lens. Now, it has been recognized that the vehicle guidance system of patent application WO 88/07560 does not and principally cannot function as required, because the amount of light that can be captured by the receiving lenses of the spaced units 12 is too small to furnish the associated transmitter lenses with sufficient light intensity, i.e. an intensity sufficient to bridge the distance from the momentarily light transmitting lens to the vehicle driver.

The present invention provides a light guide system that allows collecting substantially more ambient light, for example of vehicle headlights, and transporting the collected light by compact means to the required location(s).

A first main feature of the new light guide system is that the first unit shows a large number of light collecting apertures, instead of one aperture, i.e. the receiving lens in known light guide systems and these apertures are distributed over a surface area that is substantially larger than the surface area covered by the said receiving lens. In this way a substantially enlarged effective light receiving area is created. This is illustrated in FIG. 3, the right side portion of which shows, very schematically and for the purpose of comparison with prior art, a top view of a unit 30 of the system according to the invention. This unit has a top surface 32 with a large number of openings, or apertures, 34 which are arranged in rows 36 and columns 38. The light entering the apertures is coupled to light guides arranged within the unit 30. The left side portion of FIG. 3 shows the front surface of a receiving lens 17 of the system according to patent application WO 88/07560. The new unit 30 with apertures 34 is intended to be illuminated by a same cone of ambient light, for example of a vehicle head light, as the conventional receiving lens 17. It will be clear that the unit 30 allows collecting a portion of this cone, which portion is substantially larger than the portion that can be collected by the receiving lens 17.

A second main feature of the new light guide system is that it is made feasible for practical use, i.e. for example that it can be embedded in a roadway. If the means for transporting the light from a unit to the position where the light is needed, for example another unit, were constituted by the extensions of the light guides which start at the apertures 34, the transport means would had been too bulky. For instance, the series of light guides from a row of apertures has to be arranged on top of the series of light guides from other rows and this piling of rows of fibers would result in light transport means having a considerable height. On the other hand, a channel in a roadway for housing the optical transport means should be as shallow as possible in order to maintain the mechanical strength of the roadway. Thus it is very important that the light transporting means between the units, have small width and height and that the height of a unit is also small. This requirement is satisfied by a special design of the light guide structure within a unit. The light guides downstream the apertures stepwise compose to secondary light guides, which further compose and so on, such that the structure within a unit ends in one or a few outgoing light guides, which constitute the light transport means. By way of example, in the embodiment of FIG. 3 these means comprises two outgoing light guides 40. The light transport means thus has only a small cross-section and laying this means in a roadway does not cause any problem. The special guide light structure within a unit also allows limiting the height of the unit to a practical dimension.

To obtain a road marking system, the units 30 will be arranged one after the other in the drive direction, in a similar way as the units comprising the receiving lens 17. The drive direction is indicated by arrow 42 in FIG. 3. The distance between succeeding units 30, thus the length of the light transport means 40, may be the same or different from the distance between succeeding receiving lenses 17 of the prior art system. This distance will be prescribed by the road authority and may have a value between zero and for example 10 meters. With a distance of zero meters, i.e. the units are arranged to each other, a continuous lighting strip is obtained. If it suffices having road marks at a given mutual distance, the units are arranged at said given distance, which distance may be determined by specific circumstances, for example a bent road portion. The distance between a first unit and the most remote unit that will still receive some light from the first unit may be hundreds of meters, which is substantially different from prior art systems.

Whilst in the road marking system of patent application WO 88/07560 a mark (transmitting lens) receives light from only one aperture (receiving lens), in the system of the present invention the light received by n×m (rows and columns, respectively) is transported to at least one position, for example a mark where this light is needed. In case the latter system comprises more than one unit, a small portion of the light from the first unit is emitted at the position of the second unit. The light collected by the second unit is added to the remaining light from the first unit and transported to a third unit, and so on. This is another important feature that distinguishes the system of the present invention from the system of patent application WO 88/07560.

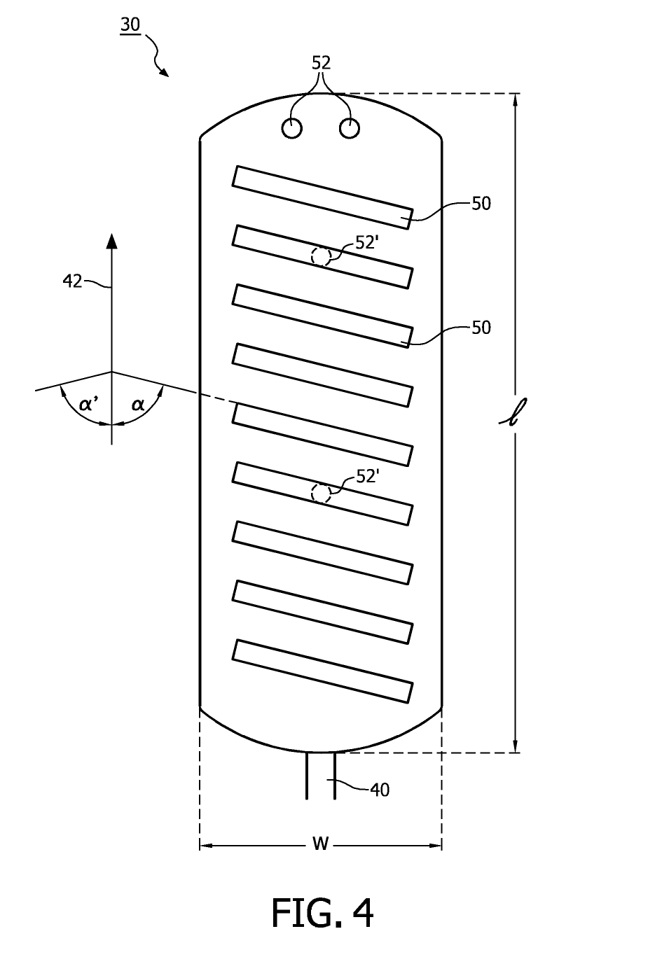

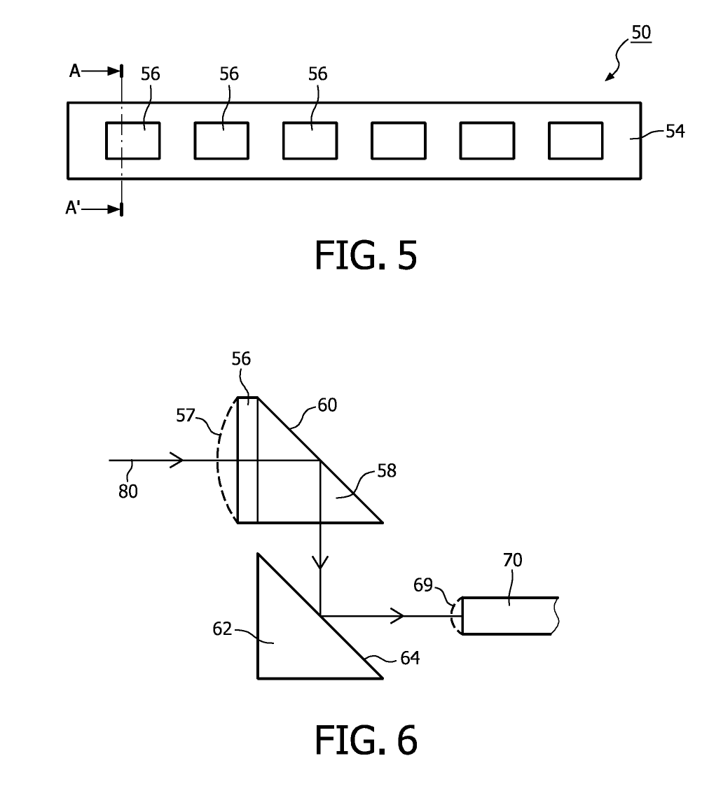

FIG. 4 shows a top view diagram of an embodiment of the novel light-collecting unit 30 for use in a road marking system. The light receiving apertures are arranged in nine rows 50. The direction of these rows with respect to the drive direction 42 is determined by the contemplated road position of the unit. The unit of FIG. 5 is intended for placement at the right edge of the road to receive maximum light from the right headlight of vehicles passing the unit. The angle cc between the rows 50 and the drive direction 42 is for example 75°. For a unit that should be placed in the middle of the row, the angle cc is larger up to some degrees less than 90° and for a unit that should be placed at the left edge of the road, α=−75° for example.

In a road marking system the elements 34 shown in FIG. 3, which were called apertures, are symbols for the light entrance side of the light guides. The light guides do not reach the surface 32 of the unit, but are arranged behind transparent windows, which transmit light incident thereon to the light guides and form a mechanical protection for the light guides and the interior of the unit. FIG. 5 schematically shows an exemplary row 50 of the unit, which comprises six windows 56 being watertight sealed in a housing 54 of, for example a plastic material or rubber. The windows may be made of quartz or another transparent material such as transparent plastics, which may be provided with a hard, protective, coating. Instead of perpendicular to the road surface or the unit plate surface, the windows may be inclined backward at an angle of, for example 1° to 1.5° with respect to a horizontal light beam from a vehicle headlight, i.e. at an angle of 89° to 88.5° with respect to the plate surface.

Behind each window a number of light guides are arranged for receiving the light transmitted by the window and transporting this light further on. The light receiving ends of these light guides could be arranged to the backside of the window. Since the ambient light enters via a vertical or slightly skew window at the top portion of the unit and should be transported horizontally in the lower part of the unit, preferably a reflecting surface, for example of a prism, is arranged behind the window to reflect the received light downwards. This provides the advantage that the light guide needs not to be bent so that it is prevented that light escapes from the light guide.

FIG. 6 shows an embodiment of the light path behind a window 56, which includes such a prism 58 having a light reflecting surface 60. The central ray 80 of a beam of light that transmits the window is incident on the surface 60 at an angle of 45° so that it is reflected in the vertical direction. At the lower side of the unit a further prism 62 having a reflecting surface 64 may be arranged, also at an angle of 45° so that it reflects the ray 80 in the horizontal direction so that the ray can enter a horizontally arranged light guide 70. The prisms 58 and 62 may be discrete elements. It is also possible that the two reflecting surfaces form the upper side and the lower side of one element. Preferably, the reflecting surfaces are integral part of the internal structure of the unit and are formed during manufacturing of the unit. Reflection at the prism surface or an inclined surface within the unit can be obtained by covering the surface with a reflecting layer. Alternatively, the surface may be arranged at such angle with the light beam that total internal reflection at the surface occur.

To direct light from the windows on the upper portion of the unit to the lower portion of the unit, under circumstance use can be made of bent fibers, instead of reflecting surfaces. To prevent considerable loss of light, the bent of fibers may not be sharp so that more unit height is required for this alternative.

The number of light guides belonging to one window 56 may be chosen by a designer and adapted to circumstances. For example the number may vary between three and nine. If five light guides are provided for each window, behind the row 50 of FIG. 5 thirty light guides will be present and the embodiment of unit 30 shown in FIG. 4 will comprise two hundred and seventy light guides. In addition to these light guides, which constitute light receiving openings, this embodiment also comprises a number of light-emitting openings 52, for example two as shown in FIG. 4. These openings are end faces of a corresponding number of, emitting, light guides included in the unit, which receive light from one or more preceding unit(s). Preferably the light-emitting openings form part of a window 56, as indicated by reference numeral 52′ in FIG. 4. Light to be transmitted may be supplied to the opening 52′ via a separate light guide or via a light guide that I already present for receiving ambient light. By way of example, the embodiment of FIG. 4 may have a length 1, in the drive direction, of 40 cm and a width w of 15 cm. The mutual distance of the units may be 10 m.

The large number of light guides allows receiving such amount of headlight or ambient light that also at larger distances sufficient light will be available for the envisaged purpose. However, the large number of light guides would made the new system not suitable for practice, because it would be too bulky, especially the mass of light guides between the units would have such volume that they cannot be embedded in a road way in an acceptable way. According to the invention this problem is solved in the following way.

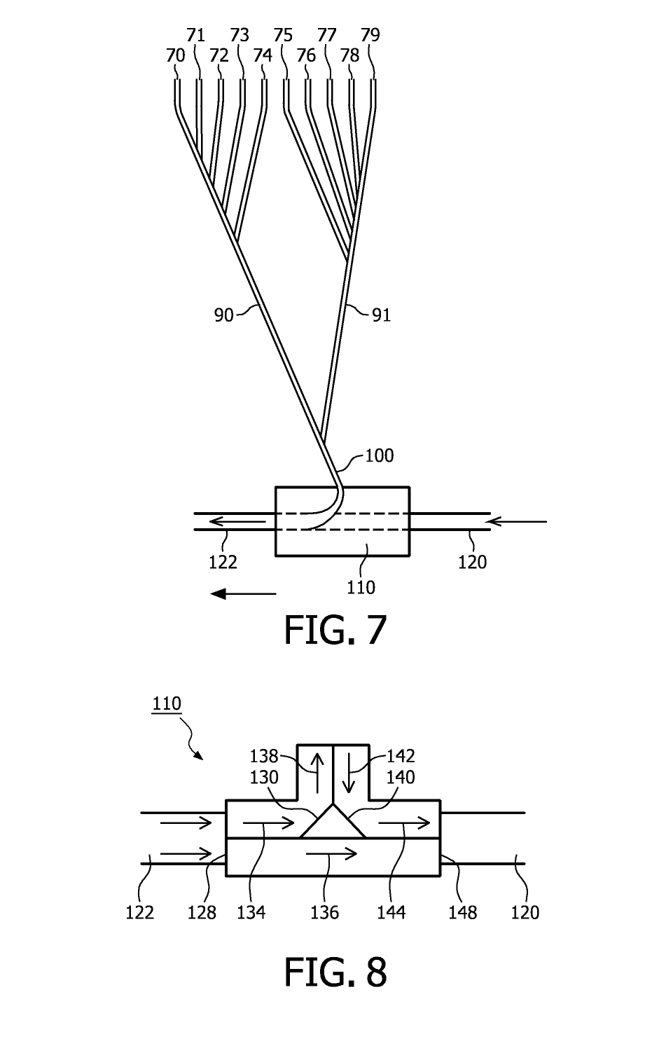

As is schematically shown in FIG. 7, the pattern of light guides 70-74 associated with one window, which may be called primary light guides, is designed such that the light guides 71, 72, 73 and 74 flow at different position along light guide 70 into this light guide, which downstream thus becomes a secondary light guide 90. The angle 13 between light guide 70 and the light guides 71-74 is such that the light propagating in the fibers 71-74 flows smoothly in light guide 70 without significant loss of light. FIG. 7 shows also a second set of light guides 75-79, which are associated with a second window of the same row. In a way similar to the first set of light guides, light guides 75-78 of the second set flow into light guide 79, which downstream thus becomes a secondary light guide 91. Also the primary light guides of the other windows of the row are composed to secondary light guides. In order to realize a further reduction of the number of light guides, the secondary light guides from all windows flow into one tertiary light guide. This is also illustrated in FIG. 7 wherein secondary light guide 91 flows into secondary light guide 90, which downstream becomes a tertiary light guide 100. All other secondary light guides of the row empty themselves into the tertiary light guide at different positions along this light guide. In this way, the thirty light receiving light guides of a row in this embodiment end into one tertiary light guide 100. This light guide is connected to optical connection means, schematically represented by block 110 in FIG. 7, wherein the light propagating through light guide 100 is transferred to an outgoing, or transporting, light guide 120. The optical connection means 110 also receives light from system units, which precede the present unit in the drive direction via one or more light-guide(s) indicated by reference numeral 122.

The optical connections means should include light splitting means and light combining means arranged at different positions within a light-collecting unit. FIG. 8 schematically shows an embodiment of these means, which, just for the sake of simplicity, are represented as forming part of one fictitious module 110. Internally, this module comprises a first reflecting surface 130, which faces the transport light guide(s) from the preceding units and supplying incident light. The surface 130 splits this light into a first portion indicated by arrow 134 and a second portion indicated by arrow 136. The first portion is reflected by the surface 130 and leaves the unit as indicated by arrow 138. This light portion propagates the unit to be emitted via openings 52 (FIG. 4) and to become visible for a vehicle driver. The second portion 136 of the incident light passes and leaves the module. The fictitious module comprises a second reflecting surface 140, which faces the tertiary light guide(s) 100 and reflects the light 142 received from these as light 144 to the exit surface 148 of the module. Light portions 144 and 136 enter the transport light guide(s) 120 to be transmitted to the next unit of the system.

The functional, light splitting and light combining, surfaces of the optical connections means are arranged at different positions within the collecting unit 30 and preferably are integrated parts, i.e. are interior faces of this unit. This provides the advantage that the unit and the connection means can be manufactured in one process. The manufacture process may be a molding process, which is well known in the art. The reflecting surfaces 130 and 140 may be constituted by reflecting layers on inclined surfaces. It is also possible that surfaces 130 and 140 are arranged at such angle with respect to light portions 134 and 142 respectively that at these surfaces total internal reflection (TIR) occurs so that no reflective layer is needed and a manufacturing step can be saved.

The new unit may be composed of a base plate, which comprises the light guide structure and the optical connector and a cover plate, which comprises the windows 56 and reflectors 60 (FIG. 6). Both plates may be manufactured by molding are casting process, which are well known by a person skilled in the art, and fixed to each other after they have been finished. The base plate may be provided with a groove structure corresponding to the required light guide structure whereby light guides in the form of optical fibers are laid in the grooves. Alternatively the grooves can be shaped such that they form optical wave-guides so that no optical fibers are needed. In case the unit is provided with optical fibers it is composed of three different components: the base plate, the cover plate and a third component comprising the fibers united with reflecting surfaces (FIG. 6) and lenses which will be discussed later on.

To increase the amount of light that is received by the light guides associated with a window, the external window surface may be shaped such that it functions as a lens. This is indicated in FIG. 6 by the interrupted curved line 57. It is also possible that the light receiving side of each fiber is provided with a lens so that the part of the light transmitting the window that enters the light guide is increased. This is indicated by interrupted curved line 69 in FIG. 6. It is also possible that a unit shows both lens features in combination.

The number of light guides 120 for connecting a unit with the next one, thus for transporting light over larger distances, can be chosen at will and in practice will be adapted to specific circumstances and the requirements of the road authority. In the embodiment of FIG. 4 having nine rows of windows, for each row a separate light guide 120 may be present. It is also possible that a separate light guide 120 serves for transportation of the light received by each two rows. Then the tertiary light guides 100 of these rows may flow together in a fourthly light guide (not shown in the Figures) that enters the optical connector 110. It is even possible that the tertiary light guides of all windows flow together in one fourthly light guide and that all the light received by the unit is transported to the next unit by means of a single light guide 120.

When used in a road marking system, specific problems occur for the new unit of the light guide system. These relate to the required mechanical strength of the plate-shaped unit and to guarantee that sufficient light can reach the windows, despite HI the fact that a roadway is a very unfriendly environment for a light-collecting device.

It is another main object of the present invention to solve these problems and to provide a plate shaped unit that is very suitable for roadway use.

In order to allow sufficient light to be collected, the unit should be provided with a large number of openings, or windows. However, discontinuities in the cover plate of the unit as a result of these openings will cause a substantial reduction of the mechanical strength of the plate if no special measures are taken. Moreover, is should be prevented that the vehicle wheels touch the windows because in that case the windows will be exposed to pushes of non-tolerable high pressure so that they may crack. The invention provides an inventive design of the unit plate, which avoids the said difficulties.

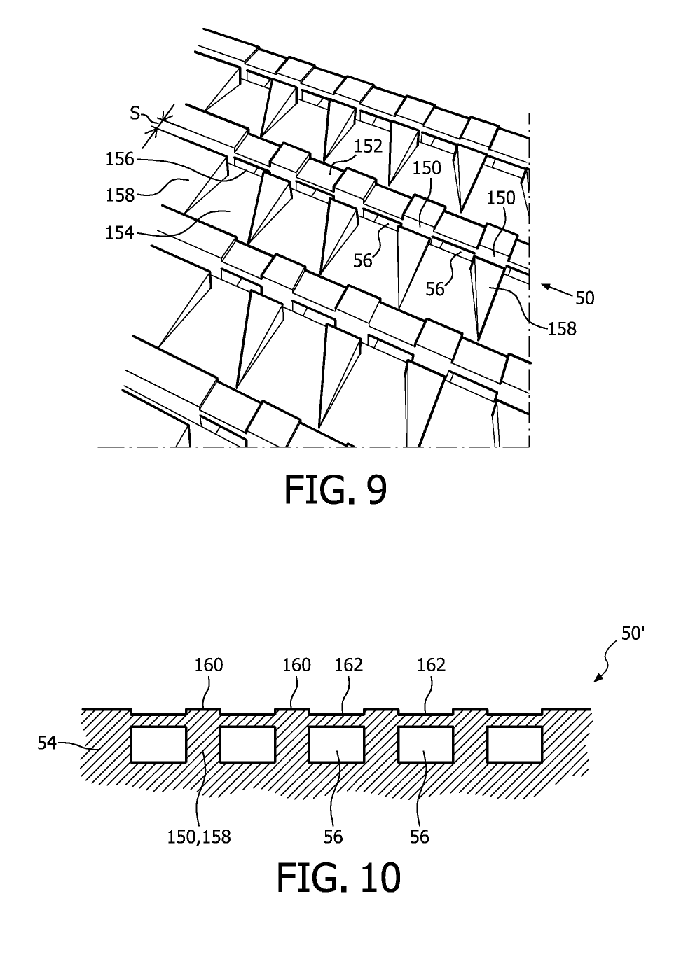

FIG. 9 shows a small portion of an embodiment of the plate-shaped unit according to this design, namely a row 50 of windows 56 amidst other rows. Each window 56 is vertically arranged and rectangular and each of its short, vertical, sides is fixed between two columns 150, whilst its upper side is fixed to a horizontal bar 152. This bar extends across all windows and columns of the row of which the window forms part. The columns and the bar are made of the same material as the rest of the unit plate. The plate surface areas 154 in front of the windows, viewed in the drive direction 42, are downwardly inclined towards the windows. At the position 156 where these areas meet the windows, the windows are fixed to them. In the opposite direction these area, which may be called light entrance enabling areas, start at the row, which precedes the present one in the drive direction. At its left side and right side each light-entrance enabling area 154 is bordered by a member 158 that is triangular-shaped in the vertical direction. The members 158 are intended for bearing vehicle wheels. The bearing members 158 between the windows are triangular-shaped also in the horizontal direction. At the side of the columns 150 the vertical cross-section of the members 158 is approximately the same as that of the columns. Between the columns 150 and the opposite bearing members 158 some space S is left, for example S≈3 mm. It will be clear that the windows 56 are accommodated in a robust frame that can withstand a considerable force so that the windows are mechanically well protected, whilst at the same time they allow sufficient light from vehicles head lights or other ambient light to be collected.

As a further improvement the upper surface of the horizontal bar is not smooth, as can be better seen in FIG. 10, which shows a front view of a row 50′ having five windows 56. The upper surface areas 160 on top of the columns 150 are raised, for example approximately 1 mm, above the surface areas 162 on top of the windows 56. Thus when a vehicle rolls across the rows of the unit, the tire of a wheel will firstly contact the surface areas 160 so that the pressure will be absorbed mainly by these areas and the underlying columns 150. In this way the windows will be better saved.

FIG. 9 shows only a small part of the embodiment of the plate-shaped unit. This embodiment may comprise, for example eighteen rows, which are provided with, for example five windows each. In case the collecting unit comprises an optical waveguide structure, behind each window at least one optical waveguide is present and in case the unit is provided with optical fibers behind each window at least three light guides may be present. This specific collecting-unit plate has a length 1=1 m, a width w=15 cm and a height h=6 cm. The unit is intended for use at the right side of a roadway. A number of units may be arranged at mutual distance of, for example 9 m to constitute a road marking system.

A roadway is a very unfriendly environment for a light collecting device, because it is frequently covered with rainwater. Not only this water, but also dirt left behind by vehicles or originating from the environment of the road, may prevent light from reaching the windows. According to the invention the plate-shaped unit is designed such that water falling down on the unit can easily flow away from it and such that air turbulence caused by wheels moving across the unit can remove dirt from it. As shown in FIG. 9, the light entrance enabling areas 154 at the side of the windows form the lowest portions of the unit where water will collect. Since there is some space S of, for example 3 mm between the wheel bearing members 158 and the columns 150, a small gutter is created along which water and dirt can flow to the surface of the road that is at a lower level than the lower side of the window.

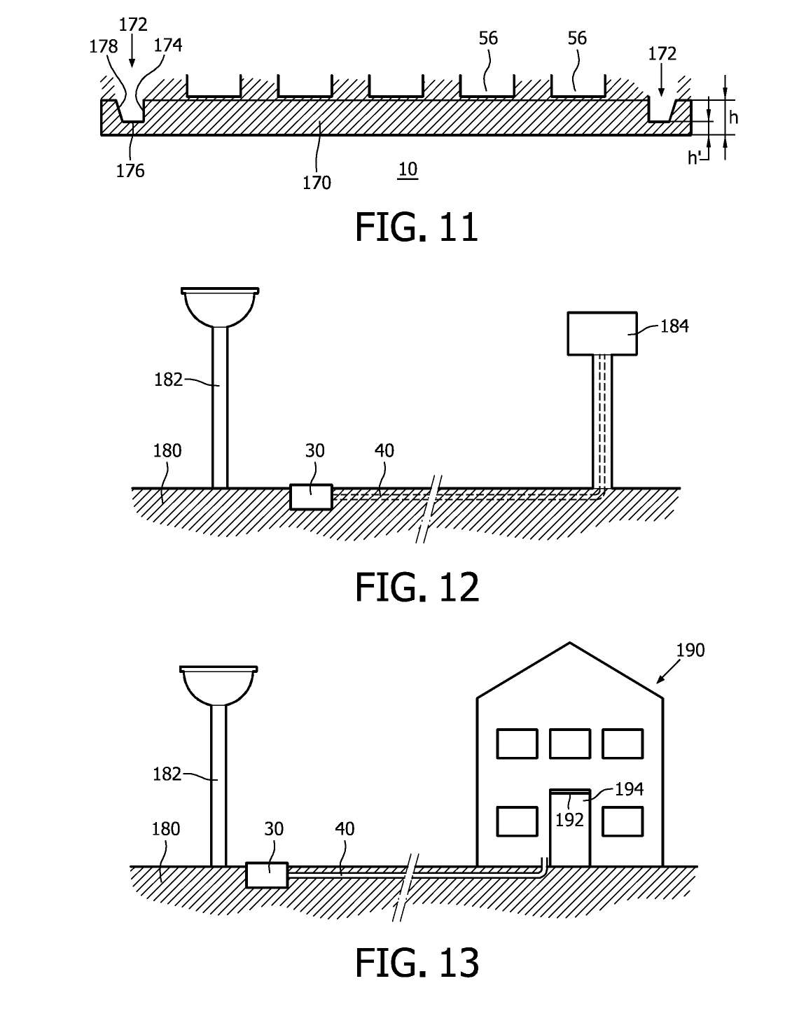

According to the invention, drain away of water and dirt can be improved by providing the left and right side of the unit plate with a groove 172 that extends in the drive direction, as shown in FIG. 11. This Figure shows a cross section, at the positions of the windows 56, of the unit plate portion 170 that rises above the surface of the road 10. The grooves 172 at the left and right sides of this portion shows a steep, for example vertical wall 174, a groove bottom 176 and an inclined wall 178. Due to the inclination of this wall, extra turbulence is generated by a vehicle wheel rolling across the collecting unit plate, which turbulence blows water and dirt from the plate. The groove 172 has, for example a depth of 6 mm, so that at the position of this groove the plate portion 170 has a thickness h′=3 mm instead of h=9 mm. In this way a substantial improved drain away of water and dirt is obtained. A further improvement can be obtained by giving the portion 170 a slight degree convex shape so that the center of that portion is higher; for example 6 mm than its left and right side ends

The above described design of the collecting unit allows accommodating it for the larger part in a row such that it extends only a few mm's above the road surface, which is very preferred by road authorities.

This unit also allows building in reflectors to reflect directly light from vehicle headlights to the driver of the vehicle. Furthermore color filters may be included ion the unit so that the emitted light has the required color, for example red if a driver has to be warned that a vehicle is ahead on the same road lane.

Light collecting units according to the concept of the invention may be arranged not only in a road surface, but also in or on a safety rail of a highway or in or on poles at the border of a road, whereby the design of the units may be adapted to the specific carrier or holder. The units may be used to illuminate all kind of traffic signs or warning devices.

The new light guide system may also be used as a warning system at cross roads. The light from one or more collecting units arranged in one road is then transported to warning signs installed at the other roads to warn traffic on the other roads that traffic is approaching the crossing from another direction.

Since a road marking system is a main application of the new light guide system, this system has been elucidated at the hand of the road marking system. Since the new light guide system shows a very high light collecting capability and very compact light transportation means, it can be used in large variety of known or new applications. For example, as is schematically shown in FIG. 12, one or more unit(s) 30, partly sunk in the street surface 180, and outgoing light guides (40), below street level, can be used to collect light from, for example street- light(s) 182 and bring this light to a remote location, outside the reach of the streetlight(s), where it is used to lit, for example a display 184.

FIG. 13 shows schematically an embodiment of a security system wherein the new light guide system is used. One or more unit(s) 30 and outgoing light guide(s) 40 collect ambient light, for example light from streetlight(s) 182 and transport this to a house or another building 190 where the light is used for a safety light 192, for example positioned above the front door 194.

The new light guide system may also be used for interior lighting of houses or buildings whereby use is made of outside ambient light, for example sunlight. The light collecting unit(s) may be placed on the roof of the house or building. Since the light transportation means of the system requires little space drastic changes in the construction of the building are not needed. This allows implementation of the new light guide system in protected monumental buildings, which should be kept in their original state.

1.-20. (canceled)

21. A light guide system for receiving and transporting ambient light by means of light guides , which system comprises at least one light collecting unit for receiving light and light transport means to transport the received light to a location remote from the unit, characterized in that the at least one light collecting unit comprises a number of light guides, the light receiving ends of which are arranged in a two dimensional array of rows and columns whilst downstream the receiving ends the light guides stepwise flow into further light guides, the number of the further light guides decreasing per step, to end in a number of outgoing transport light guides, which constitute said light transport means.

22. A light guide system as claimed in claim 21, characterized in that it comprises a number of at least one further collecting units, which include light receiving light guides arranged in a similar way as the light guides in the first collecting unit.

23. A light guide system as claimed in claim 22, characterized in that the further collecting units comprise light splitting and combining means for splitting light received from a preceding unit into a light portion that is emitted by this unit and a light portion that is transferred to the succeeding unit and for combining the light received by this unit with the transferred light.

24. A light guide system as claimed in claim 21, characterized in that the light guides of a unit stepwise flow into a number of at least one outgoing light guide.

25. A light guide system as claimed in claim 21, characterized in that each row of receiving light guide ends is arranged behind a number of spaced apart windows of transparent material, each window for passing light to a number of associated receiving light guide ends.

26. A light guide system as claimed in claim 25, characterized in that primary light guides having their light receiving ends facing a window flow into a secondary light guide.

27. A light guide system as claimed in claim 26, characterized in that secondary light guides associated with a row of windows flow into a tertiary light guide.

28. A light guide system as claimed in claim 21, characterized in that the receiving light guide ends are provided with a lens.

29. A light guide system as claimed in claim 25, characterized in that the windows are provided with a lens.

30. A light guide system as claimed in claim 25, characterized in that in the light path behind each window at least a first of first and second reflecting surfaces is arranged to reflect light to the receiving ends of the light guides.

31. A light guide system as claimed in claim 21, characterized in that the light guides are optical wave-guides.

32. A light guide system as claimed in claim 21, characterized in that the light guides are optical fibers.

33. A road marking system comprising a light guide system as claimed in claim 21, characterized in that the collecting units of the light guide system are elongated in the drive direction and arranged in a series in this direction.

34. A road marking system as claimed in claim 33, characterized in that each collecting unit comprises at least one light emitting light guide to direct light to a vehicle driver.

35. A road marking system as claimed in claim 32, characterized in that the rows of windows are arranged at an angle with the drive direction, which angle is adapted to the position of the collecting unit relative to the road width.

36. A road marking system as claimed in claim 33, characterized in that at the upper surface of a collecting unit the windows of each row are each arranged between two columns, which are perpendicular to the surface and covered by a bar parallel to the surface and in that the plate surface areas in front of the windows are declined to the lower sides of the windows and bordered by raising members.

37. A road marking system as claimed in claim 36, characterized in that in a plane parallel to the unit surface the raising members have the shape of a triangle, the top of which faces the preceding row of windows.

38. A road marking system as claimed in claim 36, characterized in that the windows of a row and the intermediate columns are covered by one bar and in that this bar has a crenellated upper surface.

39. A road marking system as claimed in claim 36, characterized in that the raising members associated with a row of windows extend from a preceding row to near the associated columns of the first mentioned row.

40. A road marking system as claimed in claim 36, characterized in that the upper surface of a unit is at both sides of the rows of windows provide with a groove that has one steep wall and one inclined wall.
